(19) United States
(12) Patent Application Publication
(10) Pub. No.: US 2012/0133075 A1
(43) Pub. Date: May 31, 2012

(54) Carbonated Beverage Delivery Tubes and Methods for Carbonated Beverage Dispensers

(75) Inventors: Timothy P. Kranz, Woodland Park, CO (US); James A. Pena, Encinitas, CA (US); Anura Welikala, Moorpark, CA (US)

(73) Assignee: STURMAN BG, LLC, Woodland Park, CO (US)

(21) Appl. No.: 13/368,082

(22) Filed: Feb. 7, 2012

Related U.S. Application Data
(62) Division of application No. 12/059,988, filed on Mar. 31, 2008.

(51) Int. Cl. B29C 45/14

(52) U.S. Cl. 264/279

(57) ABSTRACT

Carbonated beverage delivery tubes and methods for fabrication having a unitary molded structure to define a smooth beverage intake of decreasing area to a smaller diameter flexible plastic tube, and at the other end of the small diameter plastic tube, a smooth transition through an outward flaring region to decrease the velocity of the beverage without initiating foaming within the carbonated beverage delivery.

### BACKGROUND OF THE INVENTION

1. Field of the Invention

The present invention relates to carbonated beverage dispensers.

2. Prior Art

Carbonated beverage dispensers of various kinds are well known in the prior art. The present invention is primarily intended for use with carbonated beverage dispensers of the type that screw or otherwise fasten onto a beverage container, receive a source of carbon dioxide under pressure such as from a CO₂ cartridge, and maintain a regulated pressure in the beverage container for dispensing through some appropriate dispensing head. In the dispensing operation, the velocity of the beverage flow through the dispensing nozzle must be quite limited to avoid loss of carbonation in the beverage on contacting the glass or other container into which the beverage is dispensed. For this purpose, the flow from the container and the dispenser nozzle may first be through a relatively small inner diameter tube which then flares outward to a substantially larger area. The viscosity of the beverage flowing through the small inner diameter of the tube will restrict its velocity, with the flaring out of the cross sectional area in the flow path to the dispensing nozzle decelerating the beverage to a nominal dispensing velocity. Also in the dispensers of the type being discussed, the small diameter tube is typically a flexible plastic tube weighted on its distal end so that it will seek the bottom of the beverage container, irrespective of the orientation of the beverage container. A carbonated beverage dispenser of the type described incorporating the present invention may be seen in FIG. 1.

In one prior art dispenser of the type being discussed, the proximal end of the flexible plastic tube is pressed into a molded plastic member designed to mate with the proximal end of the flexible plastic tube with an inner diameter equal to that of the plastic tube, and flaring outward to a much larger area for then mating with the final dispensing tube. The distal end of the flexible plastic tube may be pressed into another molded plastic member, again mating the inner diameter of the flexible plastic tube and flaring somewhat outward to an open end to provide smooth entry for the beverage into the flexible plastic tube.

The foregoing dispensing tube can work well with many carbonated beverages. However, certain beverages have a tendency to foam, beer being a prime example. Foaming in the small diameter flexible plastic tube results in increased flow velocities in the flexible plastic tube because the foam will exhibit a much lower viscosity than the beverage itself. This, in turn, causes greater foaming, with the result that the foaming has a tendency to be an all or nothing process.

In carbonated beverage delivery tubes of the foregoing type, the molded plastic pieces forced over the ends of the flexible plastic tubes could frequently not perfectly match the inner diameters of the flexible plastic tubes because of some variation in those diameters or the wall thickness of the flexible plastic tubes, and may not fit flush against the ends of the flexible plastic tubes, leaving some gap or irregularity in the flow path. These irregularities, together with assembly variations, typically cause small local regions of substantial pressure drop, initiating foaming. Consequently the performance of such carbonated beverage delivery tubes with a beverage such as beer can be somewhat erratic, and possibly unacceptable because of their inconsistency.

### BRIEF DESCRIPTION OF THE DRAWINGS

FIG. 1 is a perspective view of an exemplary carbonated beverage dispenser incorporating a carbonated beverage deliver tube in accordance with the present invention.

FIG. 2 is a cross section of the carbonated beverage deliver tube of FIG. 1.

FIG. 3 is a cross section of the proximal end of carbonated beverage deliver tube of FIG. 1, taken on an expanded scale.

FIG. 4 is a perspective view of an exemplary mold for molding the ends of the carbonated beverage delivery tube of FIG. 1.

FIG. 5 is a face view of an exemplary mold portion for molding distal end of the carbonated beverage deliver tube of FIG. 1.

FIG. 6 is an exploded view illustrating the coupling of a larger diameter flexible tube to the carbonated beverage deliver tube of FIG. 1.

### DETAILED DESCRIPTION OF THE PREFERRED EMBODIMENTS

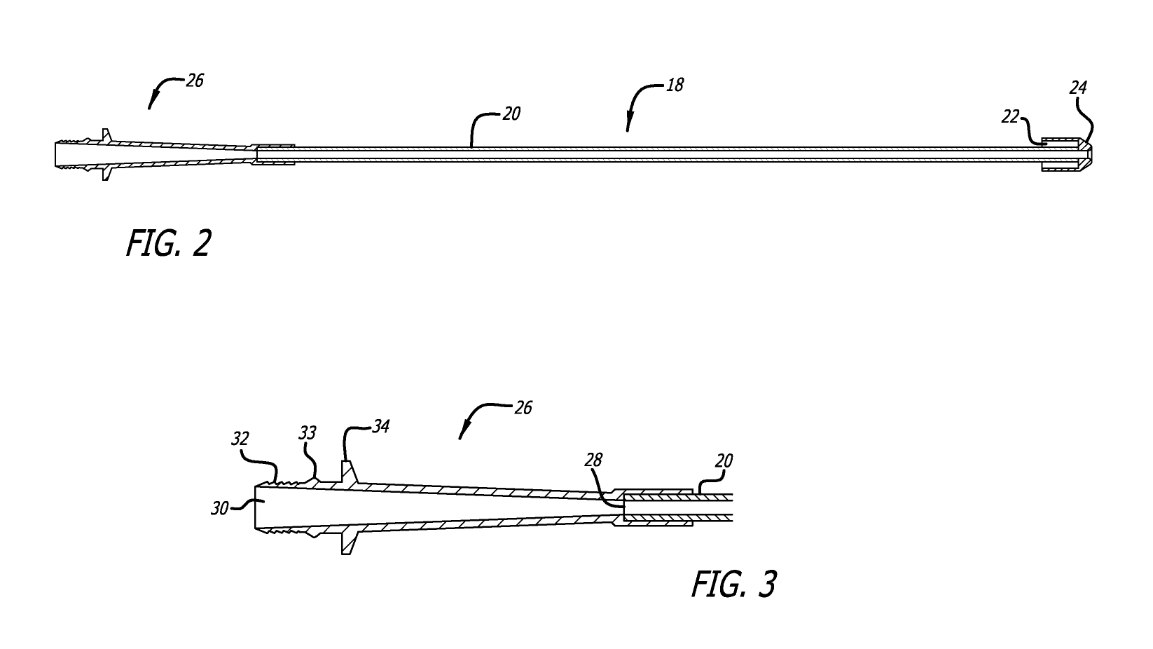

FIG. 2 is a cross section of a carbonated beverage delivery tube 18 in accordance with the present invention. The carbonated beverage delivery tube 18 is comprised of four components, specifically, a small diameter flexible plastic tube 20, a weight 22 and molded plastic region 24 on the distal end of the flexible plastic tube 20, and a molded plastic member generally indicated by the numeral 26 at the other end of the flexible plastic tube 20.

A cross section of molded plastic member 26 taken on an expanded scale is shown in FIG. 3. Molded plastic member 26 is characterized by an inner diameter in region 28, matching the inner diameter of the flexible plastic tube 20, with the inner diameter of molded member 26 flaring outward to an open end 30, typically having a cross sectional area of at least approximately 10 times the cross sectional area of the inner diameter flexible tube 20. The molded end 26 has a serrated region 32 and a local annular bump or protrusion 33 adjacent its larger end over which a final flexible dispensing tube will be pressed, and further includes a flanged region 34 for locating and locking the proximal end of the carbonated beverage delivery tube 18 into the dispensing head of the dispenser. The local annular bump or protrusion 33 causes a bulge in the final flexible dispensing tube when pressed over the bump or protrusion 33, and forms a seal with the dispenser housing when the assembly of the final dispensing tube and the delivery tube are pressed into the dispenser housing.

At the distal end of the dispensing tube, molded member 24 provides a smooth continuation of the inner diameter of the flexible plastic tube 20 and then a flaring outward therefrom to a smooth rounded end of the molded member. The carbonated beverage delivery tube 18 of FIG. 2 could be a pressed together assembly, though in accordance with the present invention, the molded members 24 and 26 are molded directly onto the flexible plastic tube 20 in a way that assures a smooth and gap free continuation of the inner diameter of the flexible plastic tube 20 where the plastic members 26 and 24 mate therewith, and are molded at a temperature which assures bonding or welding of the flexible plastic tube and the molded plastic members 24 and 26 together so as to prevent any subsequent separation between the flexible plastic tube 20 and the molded ends 26 and 24. The distal end of molded end 24 is purposely tapered as shown, so that when a beverage container is laying on it's side and the flexible tube 20 is bending down at an angle to the wall of the bottle, the inlet itself is kept away from the wall so that the inlet flow path can not be obstructed by the wall of the bottle.

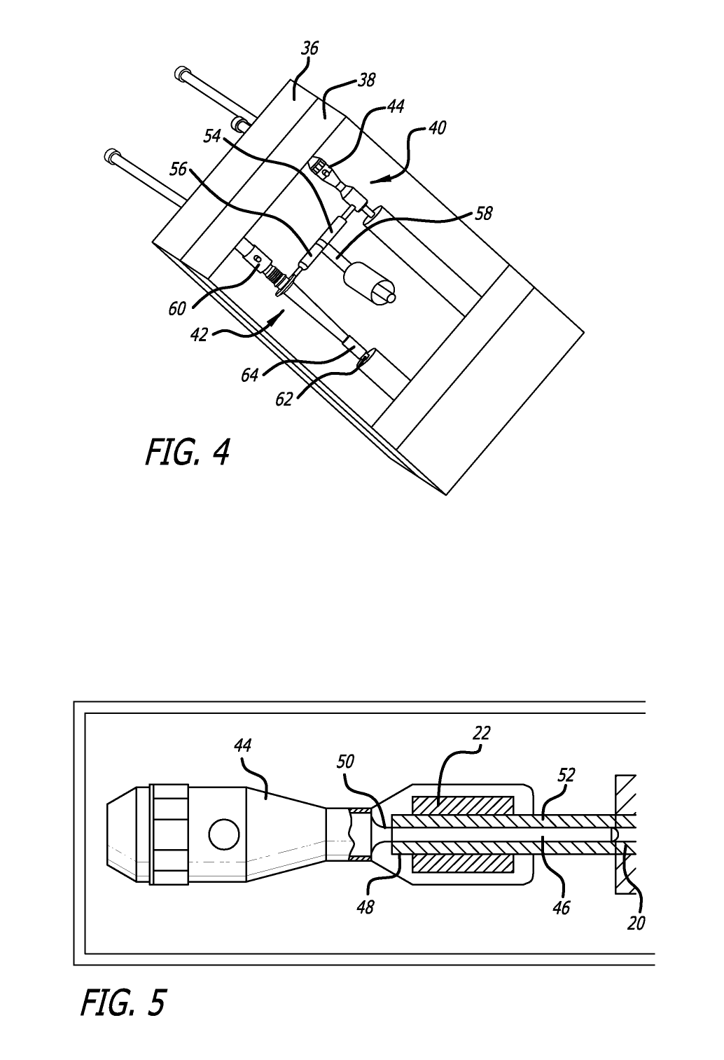

Now referring to FIG. 4, the method and apparatus for molding a carbonated beverage delivery tube 18 in accordance with the present invention may be seen. The mold is a two piece mold comprising mold halves 36 and 38 defining a mold cavity, generally indicated by the numeral 40, for the distal end of the carbonated beverage delivery tube 18 and a mold cavity, generally indicated by the numeral 42, for the proximal end of the carbonated beverage delivery tube 18, typically used for molding both ends of a single carbonated beverage delivery tube 18 in one operation.

Greater details of the mold cavity for the distal end may be seen in FIG. 5. A shut-off pin 44 having a cylindrical end region 46 with a diameter slightly larger than the diameter of the flexible plastic tube 20 extends into the plastic flexible tube 20 to a position past the weight 22. The shut-off pin 44 with the end of the flexible tube 20 forced thereover is placed in the mold with the very distal end section 48 of the flexible plastic tube 20 extending past the end of weight 22. The shut-off pin 44 defines a smooth outward flaring surface 50 to form the beverage entrance to the molded member 24 (FIG. 2).

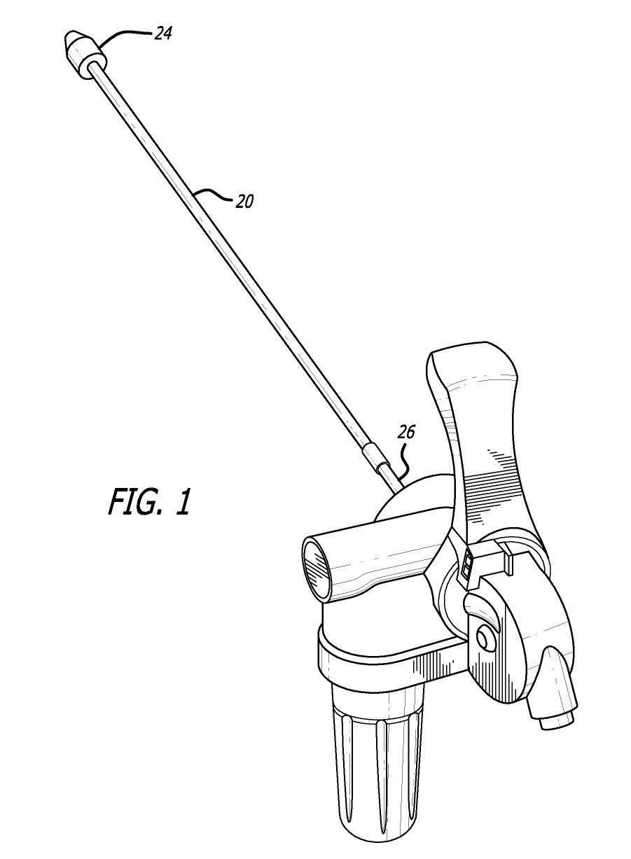

When the mold closes the two halves close tightly on region 52 of the flexible tube 20, forming a tight seal between the outer diameter of the flexible tube 20 and the mold halves and between the inner diameter of the flexible tube 20 and the shut-off pin 44. No permanent deformation of the flexible plastic tube results however, because of the support of the cylindrical end 46 of the shut-off pin 44. On molding, the plastic is injected through sprues 54 and 56 from feeder 58. In the preferred embodiment the plastic is injected in such a way as to force the weight 22 to the right as viewed in FIG. 5 against the end of the mold cavity and at a temperature so that the plastic bonds or welds to the surface of the end 48 of the plastic tube 20 and captures the weight 22, though generally leaves the back surface of weight 22 uncoated with plastic as may be seen in FIG. 1.

The molding of member 26 (FIG. 1) is similar. The shut-off pin 60 extending through region 62 of the mold cavity defines the inner surface of member 26, with the outer surface being defined by the mold cavity itself. As before, the flexible plastic tube 20 is forced over a cylindrical end of shut-off pin 60 to extend upward into region 64, the plastic when injected bonding to or being welded to the end and periphery of the flexible plastic tube 20 around its end to provide a smooth, uninterrupted transition from the inner diameter of the flexible plastic tube 20 to the outward flaring inner diameter of molded member 26. As before, the mold closes tightly around the flexible plastic tube 20 in region 62, though the inner diameter of the flexible plastic tube is not disturbed thereby because of the support the shut-off pin 60 provides.

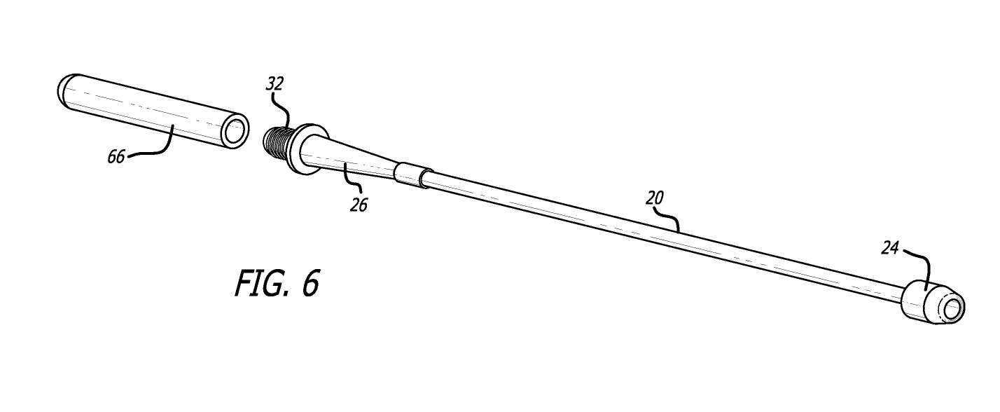

Accordingly, in accordance with the present invention, a unitary molded structure is formed defining a smooth beverage intake of decreasing area to the smaller diameter of the flexible plastic tube 20, and at the other end thereof a smooth transition through the outward flaring region of member 26 to decrease the velocity of the beverage without initiating foaming within the carbonated beverage delivery tube 18. In a typical use, the carbonated beverage delivery tubes 18 may have a second, larger inner diameter pressed over the serrated end 32 of the molded member 26, as shown in the exploded view of FIG. 6, and used in a carbonated beverage dispenser of the general type disclosed in U.S. Pat. No. 5,022,565. Of course, the molded ends of the carbonated beverage 18 may be configured differently as desired and as may be needed for carbonated beverage dispensers of other designs. Thus the present invention has a number of aspects, which aspects may be practiced alone or in various combinations or sub-combinations, as desired. While a preferred embodiment of the present invention has been disclosed and described herein for purposes of illustration and not for purposes of limitation, it will be understood by those skilled in the art that various changes in form and detail may be made therein without departing from the spirit and scope of the invention as defined by the full breadth of the following claims.

1-16. (canceled)

17. A method of fabricating pressurized beverage delivery tube comprising:
providing a first flexible tube having an inner diameter and an outer diameter;
sliding a loose fitting tubular metal weight over the outer diameter of the first flexible tube adjacent a first end of the first flexible tube;
sliding a first shutoff pin into the inner diameter of a first end of the first flexible tube so as to extend past the loose fitting tubular metal weight;
placing the first end of the first flexible tube, the loose fitting tubular metal weight and the first shutoff pin in a first mold, the first mold squeezing the first flexible tube tightly against the first shutoff pin in a region where the first shutoff pin extends into the first flexible tube past the loose fitting tubular metal weight;
the first mold having a first mold cavity defining a space around the loose fitting tubular metal weight and a space adjacent the first end of the first flexible tube, the first shutoff pin defining an outward flaring surface adjacent the first end of the first flexible tube; and,
injecting plastic into the first mold cavity to overmold the tubular metal weight at a temperature to cause the overmolded plastic to bond to the first flexible tube and to define a smooth transition between the inner diameter of the first flexible tube and the abutting inner diameter of the overmolded plastic, with the overmolded plastic having an outward flaring opening in the exposed end of the overmolded plastic defined by the first shutoff pin.

18. The method of claim 17 wherein plastic is injected into the mold cavity at a location to force the tubular metal weight against a side of the mold cavity away from the first end of the first flexible tube.

19. The method of claim 17 wherein the overmolded plastic is a rigid plastic.

20. The method of claim 17 further comprising sliding a second shutoff pin into the inner diameter of a second end of the first flexible tube;
placing the second end of the first flexible tube and the second shutoff pin in a second mold, the second mold squeezing the first flexible tube tightly against the second shutoff pin at a position separated from the second end of the first flexible tube, and otherwise defining a second mold cavity that extends around at least part of the second shutoff pin; and,
injecting plastic into the second mold cavity to form a molded end on and overlapping the second end of the first flexible tube at a temperature to cause the plastic to bond to the first flexible tube, the second shutoff pin being configured to define a smooth inner diameter from the inner diameter of the second end of the first flexible tube to the adjacent inner diameter of the molded plastic, and a smooth outward flaring of the inner diameter of the molded plastic to an open end thereof.

21. The method of claim 20 wherein the second mold cavity defines a barbed outer surface adjacent the open end of the molded end on and overlapping the second end of the first flexible tube, the barbed outer surface for pressing into a second flexible tube.

22. The method of claim 21 wherein the second mold cavity also defines a flanged area adjacent the barbed outer surface.

23. The method of claim 20 wherein the second shutoff pin defines a smooth outward flaring of the inner diameter of the molded plastic to an open end thereof having an area that is at least approximately 10 times the area defined by the area of the inner diameter of the first flexible tube.

24. A method of fabricating pressurized beverage delivery tube comprising:
sliding a shutoff pin into the inner diameter of an end of a first flexible tube;
placing the end of the first flexible tube and the shutoff pin in a mold, the mold squeezing the first flexible tube tightly against the second shutoff pin at a position separated from the end of the first flexible tube, and otherwise defining a second mold cavity that extends around at least part of the shutoff pin; and,
injecting plastic into the mold cavity to form a molded end on and overlapping the end of the first flexible tube at a temperature to cause the plastic to bond to the first flexible tube, the shutoff pin being configured to define a smooth inner diameter from the inner diameter of the end of the first flexible tube to the adjacent inner diameter of the molded plastic, and a smooth outward flaring of the inner diameter of the molded plastic to an open end thereof.

25. The method of claim 24 wherein the mold cavity defines a barbed outer surface adjacent the open end of the molded end on and overlapping the end of the first flexible tube, the barbed outer surface for pressing into a second flexible tube.

26. The method of claim 25 wherein the mold cavity also defines a flanged area adjacent the barbed outer surface.

27. The method of claim 24 wherein the plastic is a rigid plastic.

28. The method of claim 24 wherein the shutoff pin defines a smooth outward flaring of the inner diameter of the molded plastic to an open end thereof having an area that is at least approximately 10 times the area defined by the area of the inner diameter of the first flexible tube.
